(19) United States
(12) Patent Application Publication
(10) Pub. No.: US 2016/0029107 A1
(43) Pub. Date: Jan. 28, 2016

(54) In-Flow Wind Tunnel Microphone Array

(71) Applicants: Robert Patrick Dougherty, Bellevue, WA (US); Kevin James Dimond, Seattle, WA (US); Tessa Lynn Robinson, Covington, WA (US)

(72) Inventors: Robert Patrick Dougherty, Bellevue, WA (US); Kevin James Dimond, Seattle, WA (US); Tessa Lynn Robinson, Covington, WA (US)

(73) Assignee: OPTINAV, Bellevue, WA (US)

(21) Appl. No.: 14/340,894

(22) Filed: Jul. 25, 2014

(51) Int. Cl. H04R 1/02; H04R 1/40

(52) U.S. Cl. CPC H04R 1/02; H04R 1/406; H04R 1/028; H04R 2410/07; H04R 2410/01

(57) ABSTRACT

A phased microphone array capable of being placed in the free stream flow of a wind tunnel test section. The array consists of a plane of microphones on arms radiating out from a central hub. Microphones are placed along the length of the arms. The array is to be fastened to an articulated mount which allows it to be repositioned and be placed in a number of viewing positions. The ideal arms are symmetric airfoils that rotate about the longitudinal axis of the arm so that in free flow the airfoils point into the oncoming flow. Microphones placed at the leading edge will be located at stagnation points decreasing wind turbulence and boundary layer effects.

### FEDERALLY SPONSORED RESEARCH

This invention was made with government support under NNX14CC33P awarded by NASA. The government has certain rights in the invention.

### CROSS-REFERENCE TO RELATED APPLICATIONS

Not Applicable

### NAME OF PARTIES TO A JOINT RESEARCH AGREEMENT

Not Applicable

### SEQUENCE LISTING

Not Applicable

### U.S. PATENT LITERATURE

| Pat. No. | Issue Date | Patentee |
|---|---|---|
| 3,260,326 | Jul. 12, 1966 | Chen & Wheeler |
| 4,600,077 | Jul. 15, 1986 | Drever |
| 4,903,249 | Feb. 20, 1990 | Hoops, Eriksson & Allie |
| 5,288,955 | Feb. 22, 1994 | Staple, Schladt & Holmes |
| 5,477,506 | Dec. 19, 1995 | Allen |
| 5,495,754 | Mar. 5, 1996 | Starr, Pearson & Lutz |
| 5,808,243 | Sep. 15, 1998 | McCormick & Patrick |
| 5,905,803 | May 18, 1999 | Dou, Castaneda, Wu, Zak, |
| | | Yeh & Wyatt |
| 6,550,332 | Apr. 22, 2003 | Lee |
| 6,997,049 | Feb. 14, 2006 | Lacey, Jr. |
| 7,240,544 | Jul. 10, 2007 | Mallebay-Vacqueur & |
| | | Puskarz |
| 7,496,208 | Feb. 24, 2009 | Uchimura |
| 7,848,528 | Dec. 7, 2010 | Kargus & Moss |
| 7,916,887 | Mar. 29, 2011 | Cleckler, Catanzariti, Tse, |
| | | Hirai & Law |
| 8,116,482 | Feb. 14, 2012 | Cerwin & Dennis |
| 8,213,634 | Jul. 3, 2012 | Daniel |
| 8,254,616 | Aug. 28, 2012 | Bobisuthi & Gollbach |
| 8,714,003 | May 6, 2014 | Ruiz Villamil, Alvarez |
| | | Gonzales & Cobo Parra |

### FOREIGN PATENT LITERATURE

| Publication Number | Issue Date | Applicant |
|---|---|---|
| GB375471 (A) | Jun. 30, 1932 | L'Aerodynamique |
| | | Industrielle |
| GB1159443 (A) | Jul. 23, 1969 | AKG Akustische Kino |
| | | Geraete |
| DE19934260 (A1) | Feb. 3, 2000 | Schulze Brakel Schaumstoff |
| | | Und |
| JP2008020357 (A) | Jan. 31, 2008 | Railway Technical Res Inst |
| CN103487135 (A) | Jan. 1, 2014 | China Academy of |
| | | Aerospace Aerodaynamics |

### NON PATENT LITERATURE

B&K, “Technical Review: Teletechnical, Acoustical, and Vibrational Research WINDSCREENS”, No. 2, 1960
W. Neise, “Theoretical and Experimental Investigations of Microphone Probes for Sound Measurements in Turbulent Flow”, Journal of Sound and Vibration, 1975, Institut fur Turbulenzforschung, Berlin, Germany
A. Nakamura, A. Sugiyama, T. Tanak and R. Matsumoto, “Experimental Investigation for Detection of Sound-Pressure Level by a Microphone in an Airstream”, The Journal of the Acoustical Society of America, Vol. 50, Page 40, July 1971
G.R.A.S. Sound & Vibration, “G.R.A.S. RA0020 1/2” Nosecone“, http://www.gras.dk/ra0020-1.html, June 2014
DPA Microphone, “UA0777 Nose Cone”, http://www.dpamicrophones.com/en/products.aspx?c=item&category=191&item=24287, June 2014
Bruel & Kjaer, “Nose cones”, http://www.bksv.com/Products/transducers/acoustic/accessories/nose-cones, June 2014
PCB Piezotronics, “Nose Cone Protects Microphone and Ensures Sound Measurement Quality”, http://www.pcb.com/PressReleases/Acoustics/079B21_PR, June 2014
PCB Piezotronics, “Surface Microphone for Product Testing (130B40)”, http://www.pcb.com/Microphones_Preamplifiers_Acoustic_Accessories/SurfacemicTest, June 2014
Bruel & Kjaer, “4949—Automotive surface microphone with 1 coaxial cable”, http://www.bksv.com/Products/transducers/acoustic/microphones/microphone-preamplifier-combinations/4949, June 2014
Dougherty, R. P., “What is Beamforming?”, Berlin Beamforming Conference, Berlin, Germany, 2008
M. Mosher, “Phased Arrays for Aeroacoustic Testing: Theoretical Development”, AIAA/CEAS Aeroacoustics Conference, State College, Pa., May 1996
L. Koop and K. Ehrenfried, “Microphone-Array Processing for Wind-Tunnel Measurements with Strong Background Noise”, AIAA/CEAS Aeroacoustics Conference, Vancouver, British Columbia, Canada, May 2008
P. Sijtsma and H. Holthusen, “Source Location by Phased Array Measurements in Closed Wind Tunnel Test Sections”, AIAA/CEAS Aeroacoustics Conference, Seattle, Wash., May 1999
T. Ahlefeldt and L. Koop, “Microphone Array Measurements in a Cryogenic Wind Tunnel”, AIAA/CEAS Aeroacoustics Conference, pp. 3-4, Miami, Fla., May 2009
C. Horvath, E. Envia and G. Podboy, “Limitations of Phased Array Beamforming in Open Rotor Noise Source Imaging”, AIAA/CEAS Aeroacoustics Conference, pp. 2, Berlin, Germany, May 2013
H. Shin and W. Graham, “Design and Implementation of a Phased Microphone Array in a Closed-Section Wind Tunnel”, AIAA/CEAS Aeroacoustics Conference, pp. 9, Cambridge, Mass., May 2006
W. Humphreys Jr., Q. Shams, S. Graves, B. Sealey, S. Bartram and T. Comeaux, “Application of MEMS Microphone Array Technology to Airframe Noise Measurements”, AIAA/CEAS Aeroacoustics Conference, pp. 17, Monterey, Calif., May 2005
P. Raetta, R. Burdisso, W. Ng, M. Khorrami and R. Stoker, “Screening of Potential Noise Control Devices at Virginia Tech for QTD II Flight Test”, AIAA/CEAS Aeroacoustics Conference, pp. 4, Rome, Italy, May 2007
R. Stoker, R. Gutierrez, J. Larssen, J. Underbrink, G. Gatlin and C. Spells, “High Reynolds Number Aeroacoustic Testing in NASA's National Transonic Facility (NTF)”, AIAA Aerospace Science Meeting and Exhibit, pp. 5, Reno, Nev., January 2008
B. Storms, J. Ross, W. Horne, J. Hayes, R. Dougherty, J. Underbrink, D. Scharpf and P. Moriarty, “An Aeroacoustic Study of an Unswept Wing with a Three-Dimensional High-Lift System”, NASA Ames Research Center, pp. 18, Moffett Field, Calif., February 1998
R. Dougherty, “Directional Acoustic Attenuation of Planar Foam Rubber Windscreens for Phased Arrays” Berlin Beamforming Conference, Berlin, Germany, 2012
S. Jaeger, W. Home and C. Allen, “Effect of Surface Treatment on Array Microphone Self-Noise”, NASA Ames Research Center, Moffett Field, C A, 2000

A. Lauterbach, K. Ehrenfried, S. Krober, T. Ahlefeldt and S. Loose, “Microphone Array Measurements on High-Speed Trains in Wind Tunnels”, Berlin Beamforming Conference, pp. 5, Berlin, Germany, February 2010
B. Ginn and J. Hald, “Aerodynamic Noise Source Identification in Wind Tunnels Using Acoustical Array Techniques”, B&K, Naerum, Denmark
DAIMLER, “New Tool in the Battle Against Wind Resistance and Wind Noise”, http://www.daimler.com/dccom/0-5-1629046-1-1629832-1-0-0-0-0-0-0-7165-0-0-0-0-0-0-0.html, June 2014
Audi A G, “Aeroacoustic Wind Tunnel”, http://www.audi.com/corporate/en/research-and-technology/wind-tunnel-centre/aeroacoustics-wind-tunnel.html, June 2014
S2A, “The Wind Tunnels”, http://www.soufflerie2a.com/en/les-souffleries-2/, June 2014
DNW German-Dutch Wind Tunnels, “LLF”, http://www.dnw.aero/Wind-tunnels/LLF.aspx, June 2014
Boeing, “Boeing Technology Services—Low-Speed Aeroacoustic Facility,” http://www.boeing.com/boeing/commercial/techsvcs/boeingtech/bts_acoub.page, June 2014
NASA, “Low Speed Aeroacoustics Wind Tunnel (LSAWT)”, http://gftd.larc.nasa.gov/facilities/lsawt.html, June 2014
NASA, “9′×15′ Low-Speed Wind Tunnel”, http://facilities.grc.nasa.gov/9×15/, June 2014
Q. Wei, B. Chen and X. Huang, “Application of Compressive Sensing Based Beamforming in Aeroacoustic Experiment”, Berlin Beamforming Conference, pp. 7, Berlin, Germany, 2014
NASA, “40-by 80-/80-by 120-Foot Wind Tunnels”, http://halfdome.arc.nasa.gov/Research/facilities/windtunnels.html, June 2014
E. Crede, W. Devenport, R. Burdisso and R. Simpson, “Aerodynamics and Acoustics of the Virginia Tech Stability Tunnel Anechoic System”, Virginia Polytechnic Institute and State University, Blacksburg, Va., June 2008
W. Devenport, N. Alexander and S. Glegg, “Boundary Layer Ingestion into an Unshrouded Rotor: Predictions and Aeroacoustic Measurements in the VT Stability Tunnel” Virginia Tech, Florida. Atlantic University

### BACKGROUND OF INVENTION

1. Field of the Invention

The technical field of this invention relates to that of wind tunnel testing, particularly acoustics. The invention directly relates to phased imaging microphone arrays and the techniques, both physical and computational, used to negate the effects of wind turbulence over the microphones in wind tunnel tests.

2. Description of the Related Art

Wind tunnels are useful testing environments. Aerodynamic and aeroacoustic properties of models, full scale vehicles, or other subjects can be measured. However, wind tunnels happen to be noisy creating a low signal to noise environment. Excess noise is due partially to external sources generated by motors, power sources, and the like, but also internal noise that can propagate along the length of the tunnel due to the fans, flow control surfaces, and turbulent air. Turbulent air is especially problematic for microphones as it is characterized by random fluctuations in pressure. Microphones generally consist of a diaphragm which detects pressure fluctuations from sound waves; turbulent air over the microphone can have adverse effects on the readings. Due to the nature of placing microphones in moving air, this problem is certain to arise and is the source of many mitigation techniques.

Some of the most simplistic innovations for diminishing the effects of air flow have been by shielding the microphone from direct contact. Foreign Patent GB375471 (A) describes a very early attempt via a deflecting wall or wind screen which a microphone can be placed behind. This protects the microphone from direct wind and places it in the less energetic wake much like the more recent U.S. Pat. No. 7,848,528. The problem with these two methods is that the microphone is still exposed to vortices in the wake of the shield. A streamlined aerodynamic shape can nearly eliminate vortex shedding. B&K Technical Review Vol. 2 illustrates some early streamlined casings for microphones. Streamlined windscreens illustrate progression in technology, but the solid nose cone microphone probes are bigger advances. Screens are themselves sounds sources, but the nose cones can produce much smoother laminar flow over the openings to the microphones. Neise and Nakamura et al. both studied nose cone microphone probes and outline their benefits in “Theoretical and Experimental Investigations of Microphone Probes for Sound Measurements in Turbulent Flow” and “Experimental Investigation for Detection of Sound-Pressure Level by a Microphone in an Airstream”. They are still in use today with many different variations being sold by G.R.A.S, DPA, B&K, PCB Piezotronics, and many others. U.S. Pat. Nos. 5,288,955 and 5,477,506 both depict in flow microphones with nose cone covers. The problems with the nose cone microphone design are that it must be manually placed pointing directly into the oncoming flow, and even though it helps to mitigate pressure fluctuations the problem is still present.

Windscreens are briefly described in the B&K Technical Review Vol. 2. These can be made of metal mesh or more commonly foam. Foreign Patent GB1159443 (A) describes an early use of the foam. The use of these types of shields and screens can be as simple as Foreign Patent DE19934260 (A1), essentially a foam body placed directly over the microphone, or U.S. Pat. No. 7,496,208 which also pops right over the microphone but utilizes foam of different densities. These systems are relatively simple and easy to implement keeping turbulent air at a distance from the transducer membrane while allowing sound pressure waves through. Screens have become complex. U.S. Pat. No. 4,600,077 utilizes a semi-rigid internally lined cover with layers of fabric, U.S. Pat. No. 5,808,243 places the microphone inside a foam shield which is further embedded within two layers of fabric, and U.S. Pat. No. 7,916,887 depicts a transducer inside a streamlined body having acoustic ports. Eventually using complicated screens and shields begins to attenuate the target sources as well. Screens and foams are good for use in non-continuous flow environments, like stage mics or boom mics, where wind is relatively low speed and transient. Under high speed continuous flow, screens and foams become sound sources. Due to their proximity to the transducers, they are a significant interference.

Besides those already outlined, there are many other systems developed for reducing noise due to wind. These include U.S. Pat. No. 3,260,326 which places two microphones back to back with one directly in the oncoming flow. The leading microphones' signal due to the turbulent wind is used to cancel out the corresponding signal from the trailing microphone leaving just the desired source. This might help eliminate noise from a distance, but both will see different flow which generates unique turbulent noise. U.S. Pat. No. 8,254,616 utilizes a double sided diaphragm with a shunt connecting the two sides that allows pressure fluctuations due to wind through to both sides helping to cancel the effects. U.S. Pat. No. 8,116,482 uses a high frequency emitter to saturate the microphones' surroundings so that this mixes with the source identifying it from other interference. Lastly, U.S. Pat. No. 4,903,249 utilizes the nose cone probe design with a long body, the body of which is made from foam. All of these systems are unique techniques for neutralizing wind noise, but all suffer from the fact that if a probe is in a free stream there will be wind impinging on the microphone or its housing. PCB Piezotronics and B&K both sell extremely low profile microphones designed to be installed on surfaces taking advantage of a low velocity zone. At the surface, flow velocity is zero and gradually increase with distance until reaching free stream velocity. U.S. Pat. No. 5,905,803 takes this a step further by recessing the transducer and placing a film over the surface, a common configuration for arrays. In all of these systems, microphones must be exposed to turbulence in order to allow the noise source a direct path. Another issue is that the thicker and more turbulent the boundary layer, the more the sound of interest is disturbed by passing through it.

Using single microphones, the sound time history at that point will be recorded. However, using an array of microphones can provide much more information when combined with a process called beamforming. Beamforming is a mathematical algorithm that takes data sampled from an array of sensors. As a sound wave propagate across the sensors, the time and phase of the wave at each point can be used to pinpoint the source. Beamforming can produce a source intensity map and when laid on top of a reference image the location of the sources can be identified. For more information on beamforming refer to “What is Beamforming?”

There are many variations of the beamforming algorithm and many more post processing deconvolution techniques which improve the resolution of the maps and help eliminate undesired noise sources. Phased arrays offer an exciting advantage over traditional methods because of the ability to take detailed acoustic measurements in adverse and noisy environments further described in “Phased Arrays for Aeroacoustic Testing: Theoretical Development”. Wind tunnels are a perfect example of such an adverse environment. “Microphone-Array Processing for Wind-Tunnel Measurements with Strong Background Noise” and “Source Location by Phased Array Measurements in Closed Wind Tunnel Test Sections” further describe the process of phased array beamforming in wind tunnels.

Phased arrays are often planar and vary by size, configuration, and number of microphones. A specific geometric configuration may be more advantageous than another depending on the application. Arrays can be simple like the linear array in “Microphone Array Measurements in a Cryogenic Wind Tunnel”, form a more complex shape like in “Limitations of Phased Array Beamforming in Open Rotor Noise Source Imaging” which uses a log spiral pattern, or the array can even nested, also referred to as sub arrays, like in “Design and Implementation of a Phased Microphone Array in a Closed-Section Wind Tunnel” which consists of a small high frequency array inside a larger low frequency array. While configurations may vary greatly, most phased arrays are installed in the walls of tunnel test sections as can be seen in “Application of MEMS Microphone array Technology to Airframe Noise Measurements”, “Screening of Potential Noise Control Devices at Virginia Tech for QTD II Flight Test”, “High Reynolds Number Aeroacoustic Testing in NASA's National Transonic Facility (NTF)”, “An Aeroacoustic Study of an Unswept Wing With a Three-Dimensional High-Lift System”, and Foreign Patent JP2008020357 (A). Being part of the wall also helps to cut down on turbulence which an array would encounter in the free stream. However, even though phased arrays are better at negating wind turbulence, interference still remains a problem and limits array capabilities.

Mentioned earlier, array geometry can affect the results. Foreign Patent CN103487135 (A) presents an array configuration that is optimized for closed circuit wind tunnel testing. This may be an optimized geometry for attenuating noise, but possibly may not be for the type of test to be conducted. One of the most common methods for boundary layer reduction is covering the array with a low impedance material like foam. “Directional Acoustic Attenuation of Planar Foam Rubber Windscreens for Phased Arrays” studies the effects of foam rubber over phased arrays. The primary benefit of adding a screen is moving the boundary layer away from the transducers weakening its apparent intensity. An added benefit in that much of the noise propagating through wind tunnels travels at shallow angles to the walls while the source of interest is near orthogonal to the array plane. Non-boundary layer interference generally has to travel through much more foam due to the shallow angle of incidence and is thus attenuated more. Other methods of distancing the boundary layer generally consist of covering the array with other materials like U.S. Pat. No. 8,213,634 or replacing part of the tunnel wall with a layer of Kevlar sheet with the array recessed behind as is seen in “Effect of Surface Treatment on Array Microphone Self-Noise” and “Limitations of Phased Array Beamforming in Open Rotor Noise Source Imaging”. Sometimes the space in which the array is recessed is acoustically treated to create an anechoic chamber. In other cases, the boundary layer “self-noise” can mostly be eliminated by using an open test section wind tunnel, a wind tunnel where the test section itself is a room much larger than the tunnel in which a stream of air is blown over the model or test subject with the array placed away from the flow as was done in “Microphone Array Measurements on High-Speed Trains in Wind Tunnels”. This has other benefits in that the array does not need to be part of a wall and varying view angles can be obtained, but the problem that the sound of interest must pass through excess turbulence remains. With this type of tunnel other non-phased arrays can also be utilized. U.S. Pat. Nos. 6,550,332 and 7,240,544 describe methods in which microphones use dishes outside of the flow to amplify signals. Like near field holography, “Aerodynamic Noise Source Identification in Wind Tunnels Using Acoustical Array Techniques”, this technique is not capable of using beamforming and offers narrow views requiring many dishes or a way to sweep over the test model.

The majority of wind tunnels are not designed for acoustics. Open test section and open jet wind tunnels are one type of acoustic tunnel. Examples include Mercedes-Benz, Audi, the S2A tunnels, the DNW LLF, Boeing's LSAF, the NASA Langley LSAWT facilities, and those described in U.S. Pat. Nos. 5,495,754 and 6,997,049; some of which like the LFF, LSAF, and LSAWT are further acoustically treated with sound absorbing panels for walls much like U.S. Pat. No. 8,714,003. Although easier to operate phased arrays in, open test section tunnels cannot as accurately create desired test conditions making the tests less realistic. Because there are no walls to confine the stream in it can expand or contract altering the expected angle of attack on the models. Also, the boundary between stagnant and high velocity air is much more susceptible to instability which sound waves must travel through. Closed section wind tunnels that have been acoustically treated are much more desirable in this regard. Examples of these include the NASA Glenn 9 by 15 foot tunnel, the Chinese tunnel at the Aerodynamic Research Institute described in “Application of Compressive Sensing Based Beamforming in Aeroacoustic Experiment”, the NASA Ames 40 by 80 foot and 80 by 120 foot tunnels, and the Virginia Tech Stability Wind Tunnel described in “Aerodynamics and Acoustics of the Virginia Tech Stability Tunnel Anechoic System” and “Boundary Layer Ingestion into an Unshrouded Rotor: Predictions and Aeroacoustic Measurements in the VT Stability Tunnel”. The Virginia Tech tunnel is unique in that its walls can be swapped out for Kevlar sheets and that the test section sits inside an anechoic chamber. It is essentially considered a closed tunnel when it comes to flow, but open acoustically. Although all of these different types of tunnels are ideal for acoustics, they also cost more and require more time for construction.

### BRIEF SUMMARY OF THE INVENTION

The proposed invention is a specialized phased imaging microphone array for use inside a wind tunnel test section. The array consists of arms radiating from a central hub. The connection point of the arms freely rotates and the arms themselves are symmetric airfoils ensuring that they always point into the oncoming flow. Along the length of the arms are microphones, these can be placed anywhere along the arms but ideally along the leading edge where there will be stagnation points offering a reduction in turbulence. A combination of stagnant air over the transducer and advance beamforming techniques should improve spectral accuracy and resolution over current arrays. A camera is optionally positioned in the central hub for superimposing beamform maps with optical images of the model. The invention is ideally mounted on an articulated stand to hold it in the flow.

Having an array in the tunnel has the added benefit of many possible model viewing angles as opposed to one provided by arrays installed into wind tunnel walls. Many current arrays require replacing a wall in the test section with an array. This invention would simplify installation and operation potentially giving every wind tunnel acoustics capability. Microphones located at the stagnation points decrease the decorrelation effect of acoustic propagation through boundary layer turbulence. This improves the spectral accuracy of the array measurements. Improving the resolution brings concurrent benefits of reducing the effects of wall reflections at low frequency and reducing the impact of wind tunnel background noise. The in-flow array placement makes it possible to locate the sensor close to the model, improving the signal to noise ratio and the resolution.

### BRIEF DESCRIPTION OF DRAWINGS

FIG. 1 illustrates the key elements of the array.

FIG. 2 depicts a close up view of an arm.

FIG. 3 illustrates the rotational axis of an arm.

FIG. 4 depicts the aerodynamics and stagnation point of flow over an airfoil shaped arm.

FIG. 5 shows how the array would function while observing a test model.

FIG. 6 depicts a possible articulated mount for the array.

FIG. 7 graphs results from a single microphone embedded in a circular tube exposed to a free stream flow.

### DETAILED DESCRIPTION OF INVENTION

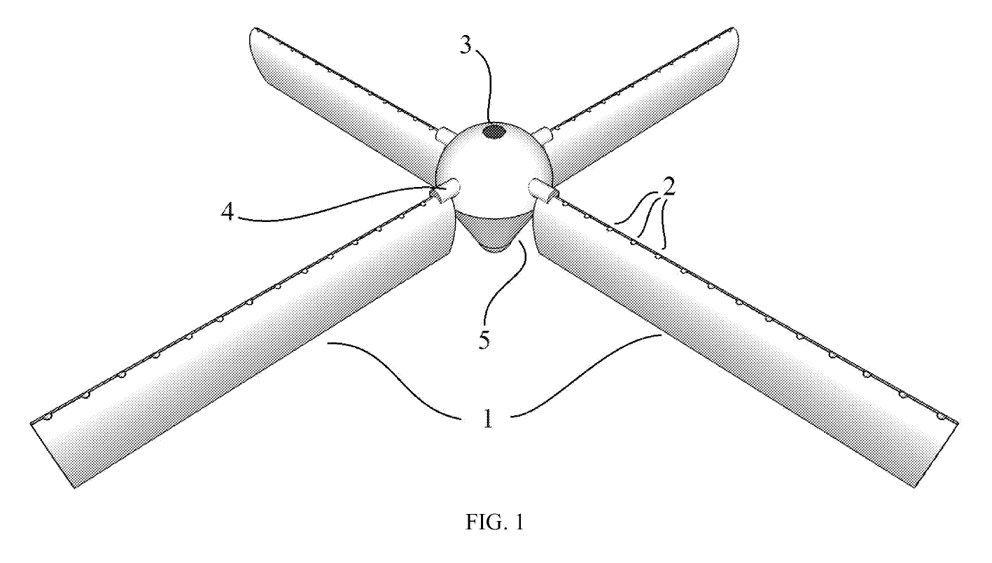

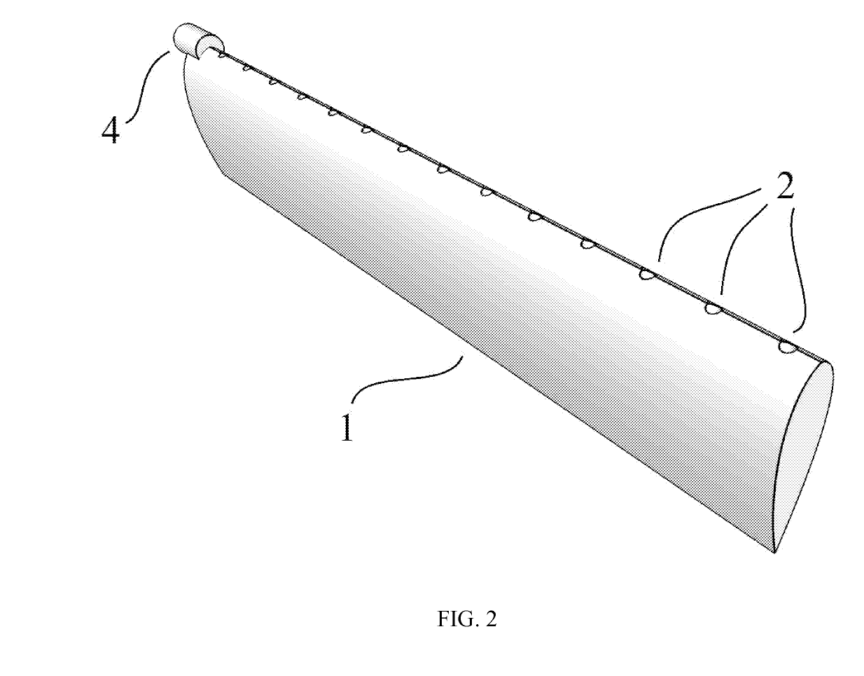

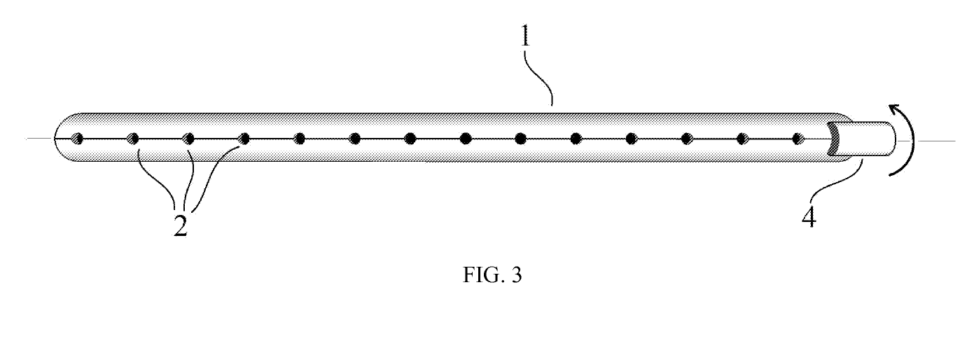

The proposed invention is a phased imaging microphone array 8. A multi-armed 1 array 8 of linear microphones 2 with a camera 3 in the center 5, as seen in FIG. 1, that is to be placed inside the test section of a wind tunnel. Best operation and results will be achieved using symmetric airfoils for arms 1 with microphones 2 mounted along the leading edge (FIG. 2), the shape of which cuts down on drag during operation. The arms 1 themselves will be designed to either freely rotate about the longitudinal axis, as shown by FIG. 3, using bearing collars 4 or some other device 4 as to always align with the air stream 7, or to be manually rotated. Locking the arms 1 in place is another option if flutter is an issue. The axis of rotation goes through the tip of each microphone 2, where the transducer's diaphragm is located, so that no matter how the arms 1 rotate the microphones 2 always stay at the same geometric location. Because the microphones 2 are omnidirectional, it does not matter how they are positioned relative to the noise source.

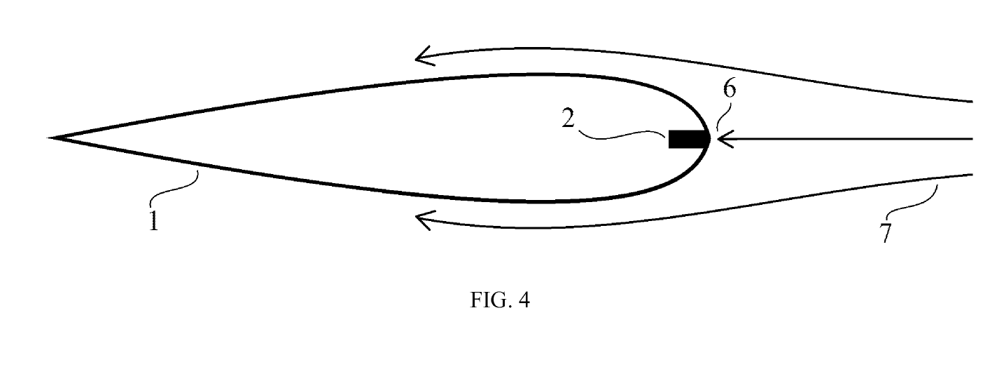

Boundary layer interference has been an issue with previous planar wind tunnel arrays. Microphones 2 are to be placed on the leading edge of the airfoils 1 where a stagnation point 6 will be FIG. 4 illustrates airflow over a symmetric airfoil arm 1 pointed directly into the stream 7. Air not directly upstream will move to either side of the airfoil 1, but air directly in front will reduce speed until reaching the leading edge surface where it will go to zero velocity and stagnate. This creates a stagnation area 6 of zero to relatively low velocity air. At this point, there is much less turbulence and a much thinner turbulent layer that is kept at a distance from the microphones 2. Ultimately, this helps limit wind interference without the need to use any of the exotic shielding and covering schemes that have been developed throughout the past. Previous techniques have either reduced the effectiveness of the microphones 2 or are difficult and complicated to implement.

Placing the microphones 2 at the stagnation points 6 creates a reduced boundary layer, when compared to wall arrays, through which sound must travel in most positions. If the array 8 is directly upstream of the model 9, sound waves would travel along the body of the airfoil 1 and be greatly affected by the boundary layer. However, directly upstream is not of particular interest as this would dirty the flow over the model 9 and may not be a realistic observer location in many aerospace applications. The other position likely to not work would be directly downstream as dirty turbulent flow coming from the test subject 9 will cause large pressure fluctuations on the microphones 2. The effectiveness of the array 8 is enhanced by using advanced beamforming and deconvolution techniques; some of which, like diagonal optimization, help eliminate boundary layer effects. New techniques are helping to increase the capability of the invention and reduce the array 8 size.

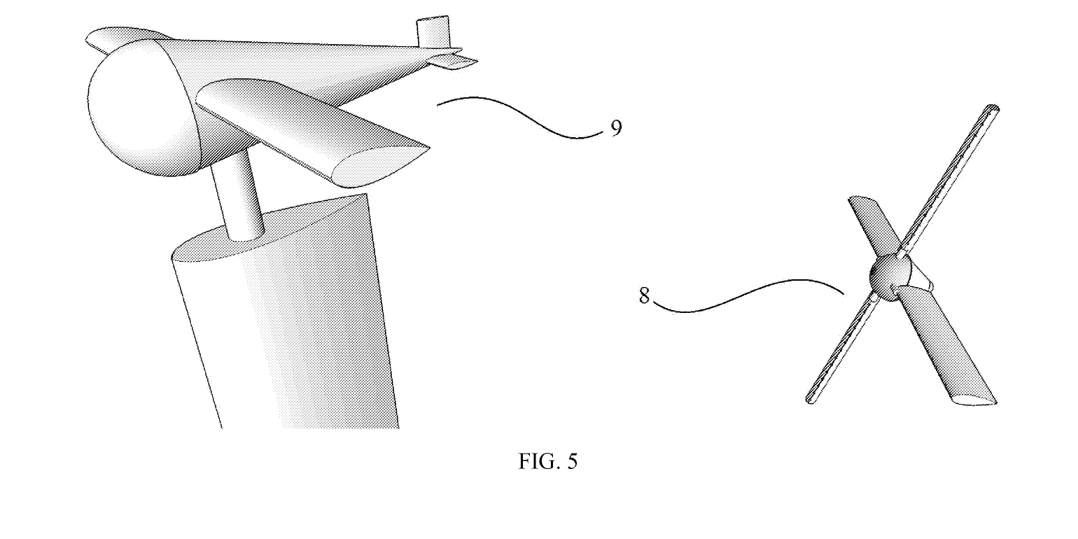

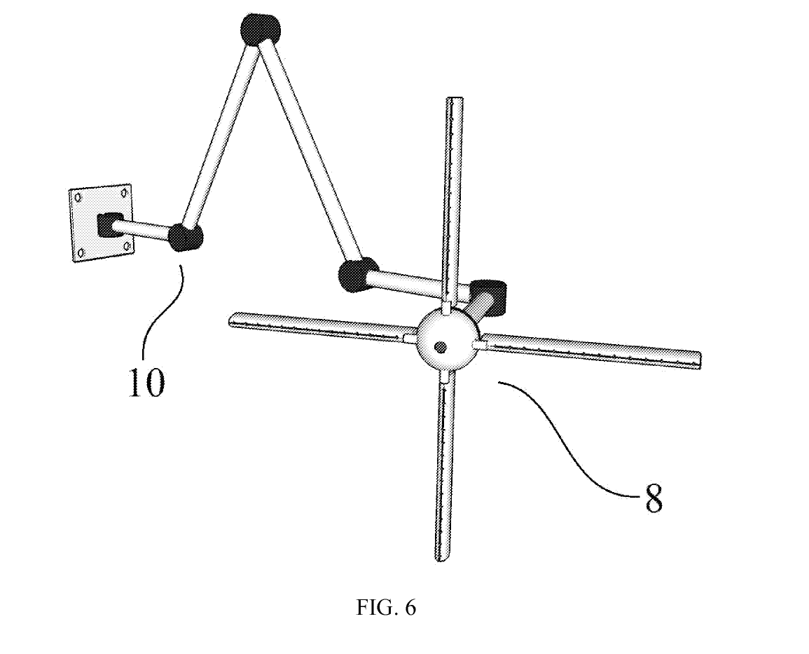

FIG. 5 depicts the array 8 in a wind tunnel during testing of a model 9. The array 8 lends itself to easily being positioned allowing for varying and close up examinations of points of interest. It is also apparent from FIG. 5 that in some positions the leading edges of the arms 1 will not be orthogonal to the direction of the flow 7. This would result in slowed air at the leading edge, but not true stagnation. It is expected that the reduction in velocity will still produce similar results. FIG. 6 illustrates how the array 8 could be mounted on the wall of a wind tunnel via an articulated mount 10. This mount 10 is not the final or only way the array 8 could be mounted, but is meant to indicate ease of installation. Compared to current arrays that require replacing a wall in the test section, this takes up relatively little space and requires less retrofitting. It would be easy to install when carrying out acoustic testing and easy to detach when not needed.

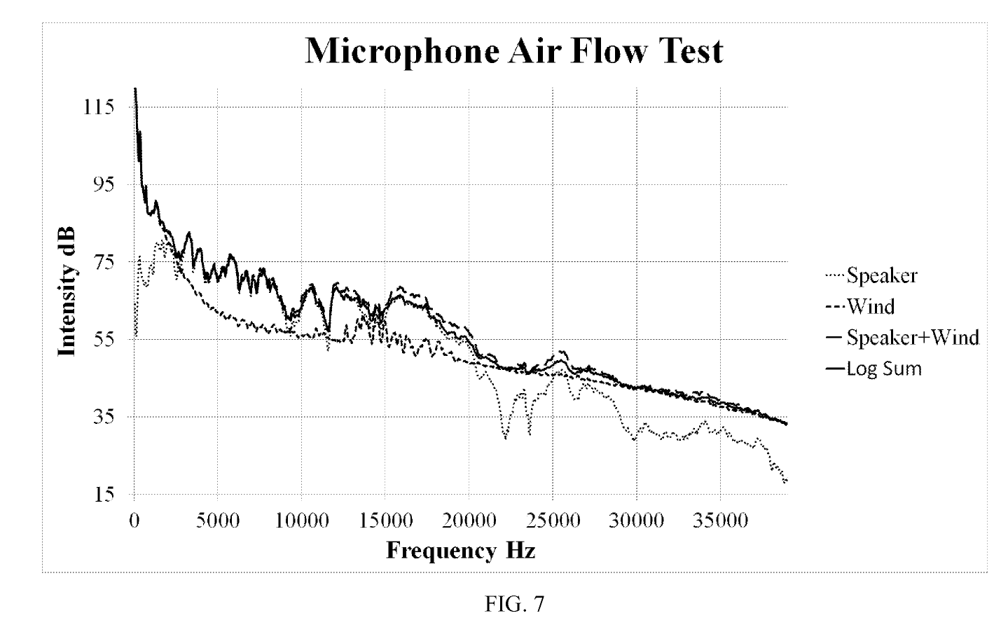

An important aspect of the innovation is that the microphones 2 will be operating in flow 7. A test was conducted to verify the operation of a microphone exposed to airflow similar to that which the innovation would operate under. The test was carried out using an Earthworks M30 microphone embedded in a 1.5 inch diameter ABS pipe. The rounded nature of the pipe simulates the leading edge of an airfoil. The microphone was placed approximately 0.5 inches from the exit of a blower; airflow was approximately 50.6 m/s or Mach 0.15, typical speeds for a wind tunnel. A speaker generating white noise was placed off to the side of the pipe. Data was collected with the speaker, the wind, and with both, presented in FIG. 7, along with the log sum of the speaker and wind individually. The results match expectations: the log sum spectrum matches the measurement with both the white noise and the wind. FIG. 7 shows that microphones 2 can operate in a wind tunnel environment on a leading edge without boundary layer effects making the operation impossible. Sound data can be collected and further refinement can isolate the desired signal.

1. A microphone array to be used in the free stream of a wind tunnel comprising:
(a) a central hub
(b) arms branching outward from the hub
(c) a plurality of microphones flush mounted on the arms.

2. The array defined in claim 1 placed upon an articulated mechanical mount or other supporting member that can move for repositioning.

3. The array defined in claim 1 wherein the arms have a symmetric airfoil shape.

4. The array defined in claim 1 wherein the arms are installed pivotably.

5. The array defined in claim 3 wherein the microphones are installed at the leading edges of the arms.
